(19) United States
(12) Patent Application Publication
(10) Pub. No.: US 2026/0300602 A1
(43) Pub. Date: Oct. 1, 2026

(54) AUTO LAYOUT METHOD FOR TRANSISTORS IN STANDARD CELLS, DEVICE AND STORAGE MEDIUM

(71) Applicant: HUAZHONG UNIVERSITY OF SCIENCE AND TECHNOLOGY, Hubei (CN)

(72) Inventors: Xingsheng Wang, Hubei (CN); Zhanpeng Wu, Hubei (CN); Xiaofan Wang, Hubei (CN); Xiangshui MIAO, Hubei (CN)

(73) Assignee: HUAZHONG UNIVERSITY OF SCIENCE AND TECHNOLOGY, Hubei (CN)

(21) Appl. No.: 19/393,570

(22) Filed: Nov. 19, 2025

(30) Foreign Application Priority Data
Mar. 26, 2025 (CN) 202510361452.0

(51) Int. Cl. G06F 30/392

(52) U.S. Cl. CPC G06F 30/392

(57) ABSTRACT

An auto layout method for transistors in standard cells, a device, and a storage medium are disclosed. The method includes: obtaining transistor information; pairing NMOS and PMOS with common gates, if there are remaining unpaired transistors, then setting virtual transistors to pair with them, respectively placing NMOS and PMOS in different sequences, randomly initializing sequences while ensuring that paired transistors are always aligned in positions in the sequences; executing hill climbing algorithm, getting adaptive initial layout of sequences, and calculating adaptive initial temperature T=2*S÷U of sequences, where S is accumulation of score changes obtained from each hill climbing, U is hill climbing count, layout score is weighted sum of transistor layout indicators; executing simulated annealing algorithm, getting final layout of sequences.

### CROSS-REFERENCE TO RELATED APPLICATION

This application claims the priority benefit of China application serial no. 202510361452.0, filed on Mar. 26, 2025. The entirety of the above-mentioned patent application is hereby incorporated by reference herein and made a part of this specification.

### BACKGROUND

### Technical Field

This disclosure belongs to the technical field related to layout design, and more specifically, relates to an auto layout method for transistors in standard cells, a device, and a storage medium.

### Description of Related Art

The standard cell library includes layout libraries, symbol libraries, circuit logic libraries, etc., and is a fundamental part of the back-end design process for integrated circuit chips. Using pre-designed optimized library cells for automatic logic synthesis and layout placement and routing may greatly improve design efficiency.

In layout, conventional approaches typically involve transistor layout, i.e., forming transistor standard cells. Currently, this is generally performed through semi-automatic design using EDA tools, and this process requires manual participation for adjustment, which is time-consuming and labor-intensive.

Therefore, it is necessary to propose an auto layout method to achieve rapid layout of transistors within standard cells and ensure local effects.

### SUMMARY

For the above defects or improvement requirements of the existing technology, the disclosure provides an auto layout method for transistors in standard cells, a device, and a storage medium, which aims to achieve auto layout of transistors on the basis of satisfying transistor connection characteristics and improve layout efficiency.

To achieve the above objective, the disclosure provides an auto layout method for transistors in standard cells, which includes:
step S1: obtaining information of each of NMOS transistors and PMOS transistors to be laid out;
step S2: pairing the NMOS transistors and the PMOS transistors with common gates, if there are remaining unpaired transistors, then set virtual transistors to pair with them, placing the NMOS transistors and the PMOS transistors in different sequences respectively, randomly initializing positions of each transistor in the sequences while ensuring that the paired transistors are always aligned in their positions within the sequences;
step S3: with a sequence layout as an optimization target and a highest layout score as an optimization objective, executing a hill climbing algorithm to get an adaptive initial layout of the sequence, and calculating an adaptive initial temperature T=2*S÷U of the sequence, where S is an accumulation of score changes obtained from each hill climbing, U is a hill climbing count, and the layout score is a weighted sum of transistor layout indicators;
step S4, based on the adaptive initial layout and the adaptive initial temperature, executing a simulated annealing algorithm to get a final layout of the sequence;
step S5: arranging the transistors in the sequence as the layout of the transistors.

Optionally, in step S4, several rounds of exploratory simulated annealing algorithm are executed first, with the layout having the highest layout score as an initial solution to continue executing the simulated annealing algorithm until completion.

Optionally, 5 rounds of the exploratory simulated annealing algorithm are executed first.

Optionally, in step S4, a process of executing the simulated annealing algorithm includes:
step S41: taking a current layout of the sequence as a current solution i, let an optimal solution S=i;
step S42: disturbing the current solution i to get a new solution j, if score f(j)>f(i), then accept the new solution j and update S-j, otherwise, calculate probability P=e^{([f(j)-f(i)]/t)} and generate a random number greater than 0 and less than 1, if the random number is less than P, then accept the new solution j; t being a current temperature;
step S43: reducing the temperature t;
step S44: repeating step S42 to step S43 until the temperature t is less than a termination temperature or solution converges, outputting the optimal solution.

Optionally, the disturbance includes performing 180° rotation of the transistors, transistor position exchange, and transistor position movement.

Optionally, if there are transistors with widths exceeding standard cell dimensions, their widths are folded to adapt to dimensions of the standard cell.

Optionally, step S5 includes: arranging the transistors in the sequence as the layout of the transistors, getting layout information of the transistors, writing the layout information of the transistors, transistor connection information, and netlist node connect information into a file in json format, getting the json format file of the layout.

Optionally, the layout indicators include area, wire length, pin accessibility, layout symmetry, design rule check, and program runtime.

The disclosure also provides an electronic device, including a memory and a processor, the memory stores a computer program, and the processor implement the steps of the method according to any one of the above when executing the computer program.

The disclosure also provides a computer-readable storage medium having a computer program stored thereon, wherein the computer program implements the steps of the method according to any one of the above when executed by a processor.

Overall, through the technical solutions conceived by the disclosure compared with the prior art, the disclosure mainly has the following beneficial effects:
1. The transistor auto layout method provided by the disclosure, on one hand, before performing layout optimization through optimization algorithm, first makes the positions of transistors with common gates always aligned through pairing method, this constraint may completely ensure that transistors with common gates in the final layout result share gate nets, meeting the requirements of actual standard cells for transistor layout, improving layout success rate, on the other hand, when performing layout optimization, combines hill climbing algorithm and simulated annealing algorithm, first understands the situation of transistors of the current standard cell to be constructed through hill climbing algorithm, records data in the hill climbing process, calculates an adaptive initial temperature that may adapt to the current transistor situation based on the data of hill climbing algorithm and uses it as the temperature starting point of simulated annealing algorithm, especially the setting of adaptive temperature starting point, may make the overall probability of accepting worse solutions in the simulated annealing process adjusted to approach P=e^{-0.5}, compared to traditional simulated annealing process setting the initial temperature very high resulting in the probability of accepting worse solutions approaching 1, the disclosure enhances the randomness of accepting worse solutions, will not overly favor accepting worse solutions, compared to traditional algorithms, the disclosure executes simulated annealing algorithm with shorter convergence time, higher efficiency, and better layout effect;
2. optionally, the simulated annealing algorithm may be executed twice in succession, and by exploring the initial solution, the layout score in the iterative process may converge relatively stably with basically no large fluctuations, thereby further accelerating the convergence speed;
3. optionally, if there are transistors with widths exceeding the standard cell dimensions, their widths may be folded to adapt to the standard cell dimensions, thus reducing area waste of the standard cell.

### BRIEF DESCRIPTION OF THE DRAWINGS

FIG. 1 is a step flow chart of an auto layout method according to an embodiment of the disclosure.

FIG. 2 is a step flowchart of simulated annealing algorithm according to an embodiment of the disclosure.

FIG. 3 is a disturbance method according to an embodiment of the disclosure.

FIG. 4 is a relationship curve between temperature and probability in the simulated annealing algorithm.

FIG. 5 is a change situation of layout score during simulated annealing algorithm according to an embodiment of the disclosure.

FIG. 6 is a visualization image of standard cells obtained according to an embodiment of the disclosure.

FIG. 7 shows a comparison of layout results through the method of the disclosure and conventional tools.

### DESCRIPTION OF THE EMBODIMENTS

In order to make the objectives, technical solutions and advantages of the disclosure clearer, the disclosure will be described in further detail below with reference to the accompanying drawings and embodiments. It should be understood that the specific embodiments described herein are merely used to explain the disclosure and are not used to limit the disclosure. In addition, the technical features involved in the various embodiments of the disclosure described below may be combined with each other as long as they do not conflict with each other.

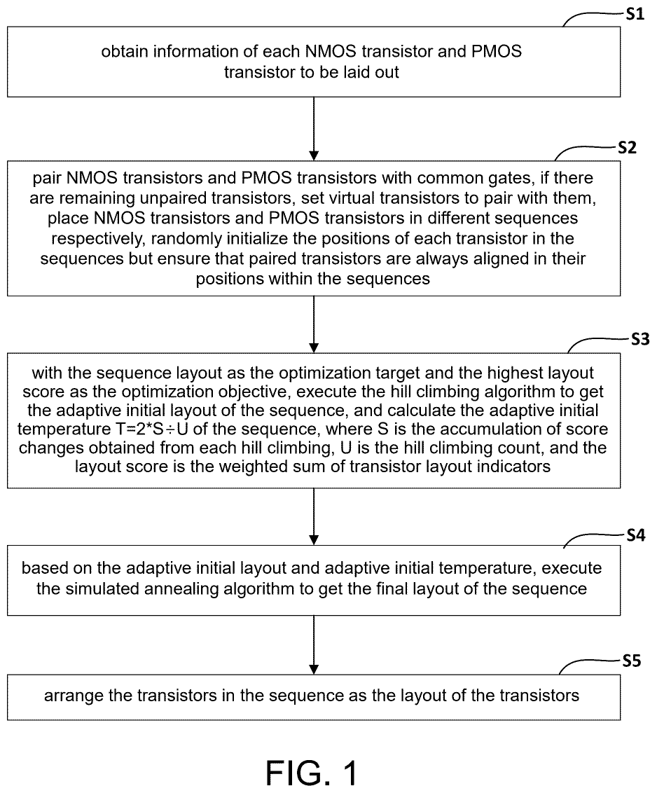

The disclosure provides an auto layout method for transistors in standard cells. As shown in FIG. 1, FIG. 1 is a step flow chart of an auto layout method according to an embodiment of the disclosure. The steps therein are introduced below.
Step S1: obtain information of each NMOS transistor and PMOS transistor to be laid out.

Specifically, before constructing the standard cell of transistors, it is necessary to first clarify the information of each transistor, that is, the number of transistors, the parameters of each transistor, the electrical connection relationship between transistors, etc. After clarifying the above information, all transistors are then optimized for layout to obtain the standard cell of transistors.

In specific operations, a parser may be utilized to read netlist information in the data path and interpret the information of each transistor.
Step S2: pair NMOS transistors and PMOS transistors with common gates, if there are remaining unpaired transistors, set virtual transistors to pair with them, place NMOS transistors and PMOS transistors in different sequences respectively, randomly initialize the positions of each transistor in the sequences but ensure that paired transistors are always aligned in their positions within the sequences.

When constructing transistor standard cells, they are typically arranged in two horizontal rows, with the first row placing PMOS transistors and the second row placing NMOS transistors. The horizontal direction is defined as the X direction, the vertical direction as the Y direction, and the upper and lower transistors are aligned along the Y direction.

Constructing the standard library is key to determining which position each PMOS transistor is at in the first row, and determining which position each NMOS transistor is at in the second row, that is, performing layout optimization on the positions of the transistors.

Therefore, the disclosure constructs two sequences, the first sequence for the arrangement order of PMOS transistors, and the second sequence for the arrangement order of NMOS transistors. Before initializing the sequences, the disclosure first pairs transistors according to the electrical connection relationships of the transistors, pairing NMOS transistors and PMOS transistors with common gates. If there are remaining unpaired transistors, virtual transistors are set to pair with them, so that all transistors complete pairing, with each pair having two transistors. During subsequent initialization and layout optimization, the two transistors with pairing relationships always maintain aligned positions in the two sequences. For example, if the first PMOS transistor and the first NMOS transistor have a pairing relationship, then the position of the first PMOS transistor in the first sequence always remains the same as the position of the first NMOS transistor in the second sequence. The disclosure refers to this as dual arrangement. Since the gate connection relationships of transistors usually appear in pairs, with each transistor corresponding to one gate net, in specific operations, each gate net may be traversed. If the gate net is even, pairs are formed according to circuit connection relationships and placed at relative positions in the two sequences; if odd, pairs are first formed according to circuit connection relationships, then the remaining unpaired transistors are paired with virtual transistors, and the gate of the virtual transistor is set to be the same as the gate of its paired transistor.

If transistors are initially randomly placed in two sequences, and whether the gate nets of two transistors at the same X coordinate position are consistent is added as an optimization target to the subsequent optimization algorithm, there is a high probability that a dual arrangement result may not be obtained, and it may increase the burden of the subsequent optimization algorithm. Therefore, the disclosure proposes a transistor pairing algorithm and virtual transistor method, which may improve the quality of optimization solutions and reduce the search space of the optimization algorithm, accelerate the efficiency of subsequent algorithm optimization, and improve the quality of the final solution.

In one embodiment, preprocessing of transistors is further included. Before physical design, the height of the standard cell (whose height direction corresponds to the width direction of the transistor) has already been determined. For some transistors with very large widths that cannot be placed into the standard cell, or require standard cells with greater height, causing area waste, this embodiment performs folding operations on these transistors along the width direction to make their widths adapt to the height of the standard cell. In this way, area waste may be reduced. All information of the folded transistor except width information is consistent with the original transistor information.

In one embodiment, in order to obtain more layouts with shared active regions and reduce layout area, when folding transistors, transistors with larger widths may be folded. When folding into n≥3 segments is required, at least n−1 segments have the same width. For example, when the height of a standard cell is 240 nm, a 550 nm transistor needs to be folded into 3 fingers, where two fingers have the same width. For example, it may be split into two 215 nm fingers and one 120 nm finger.

Randomly initialize two sequences, but ensure that paired transistors are always aligned in position in the sequences, and enter the subsequent layout optimization algorithm.
Step S3: with the sequence layout as the optimization target and the highest layout score as the optimization objective, execute the hill climbing algorithm to get the adaptive initial layout of the sequence, and calculate the adaptive initial temperature T=2*S÷U of the sequence, where S is the accumulation of score changes obtained from each hill climbing, U is the hill climbing count, and the layout score is the weighted sum of transistor layout indicators.

Specifically, before performing layout optimization, it is necessary to determine indicators for evaluating the quality of the layout, and construct an optimization target based on the evaluation indicators. In the disclosure, a layout score is obtained by performing weighted summation based on optimization indicators of transistors, and the optimization target is to maximize the layout score. The determination of indicators may be flexibly selected according to actual situations.

For example, selectable indicators may include: area ws, wire length bs, pin accessibility ps, layout symmetry, design rule check drc, program runtime rs.

In this step, with the sequence layout as the optimization target and with achieving the highest layout score as the optimization objective, the hill climbing algorithm is executed to get the adaptive initial layout of the sequence, while calculating the adaptive initial temperature of the sequence T=2*S÷U, where S is the accumulation of score changes from executing each hill climbing, and U is the hill climbing count.

The hill climbing algorithm simulates the process of hill climbing, starting from an initial point and continuously moving to higher points (i.e., better solutions) until reaching a local highest point (i.e., local optimal solution). In the disclosure, through the hill climbing algorithm, the random initialization in step S2 may be optimized to get a relatively good initial solution. Moreover, by recording hill climbing data, calculating the change amount of layout score for each hill climbing and calculating the accumulation S of score change amounts in the entire hill climbing process, based on the accumulation of score change amounts and hill climbing count U, an adaptive initial temperature T=2*S÷U is calculated, with the adaptive initial layout obtained by hill climbing as the starting point for the subsequent simulated annealing algorithm, and with the adaptive initial temperature as the initial temperature for the subsequent simulated annealing algorithm.
Step S4: based on the adaptive initial layout and adaptive initial temperature, execute the simulated annealing algorithm to get the final layout of the sequence.

The simulated annealing algorithm is a probability-based algorithm derived from the solid annealing principle. It simulates an optimization process where a solid is heated to a sufficiently high temperature and then gradually cooled, achieving equilibrium at each temperature and ultimately reaching the ground state at room temperature with minimum internal energy.

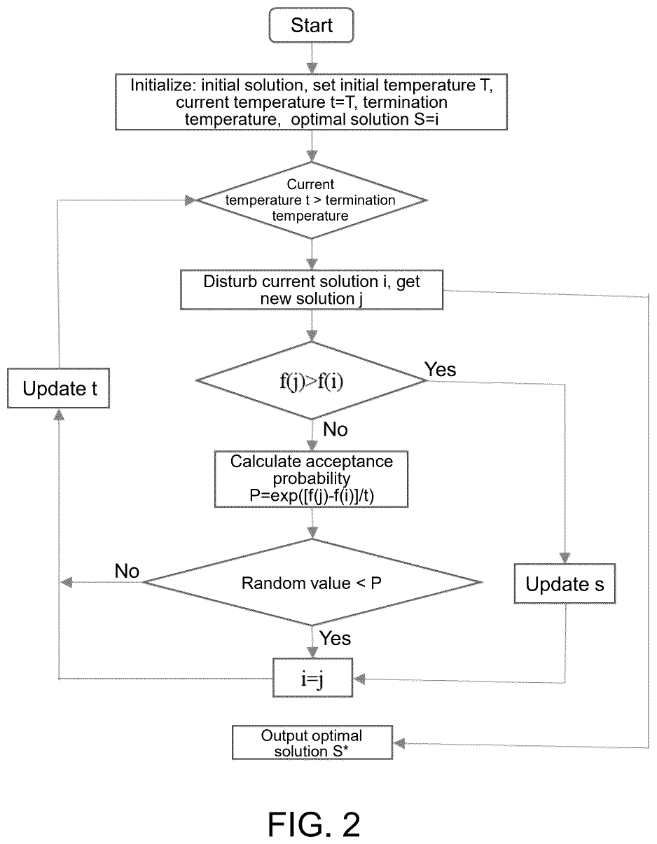

Specifically in this scenario, as shown in FIG. 2, the specific process of the simulated annealing algorithm is as follows:
Step S41: take the current layout of the sequence as current solution i, and set optimal solution S=i.
Step S42: disturb current solution i to get new solution j, if score f(j)>f(i), then accept new solution j and update S=j, otherwise, calculate probability P=exp^{([f(j)-f(i)]/t)} and generate a random number greater than 0 and less than 1, if the random number is less than P, then accept new solution j; t is current temperature.

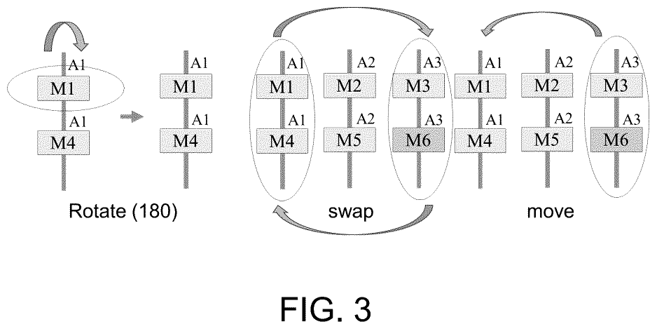

In one embodiment, the disturbance is adjusting the layout of the sequence, for example, performing rotation, exchange, movement, etc. as shown in FIG. 3.
Step S43: reduce temperature t.
Step S44: repeat step S42 to step S43 until temperature t is less than termination temperature or solution converges, output optimal solution.

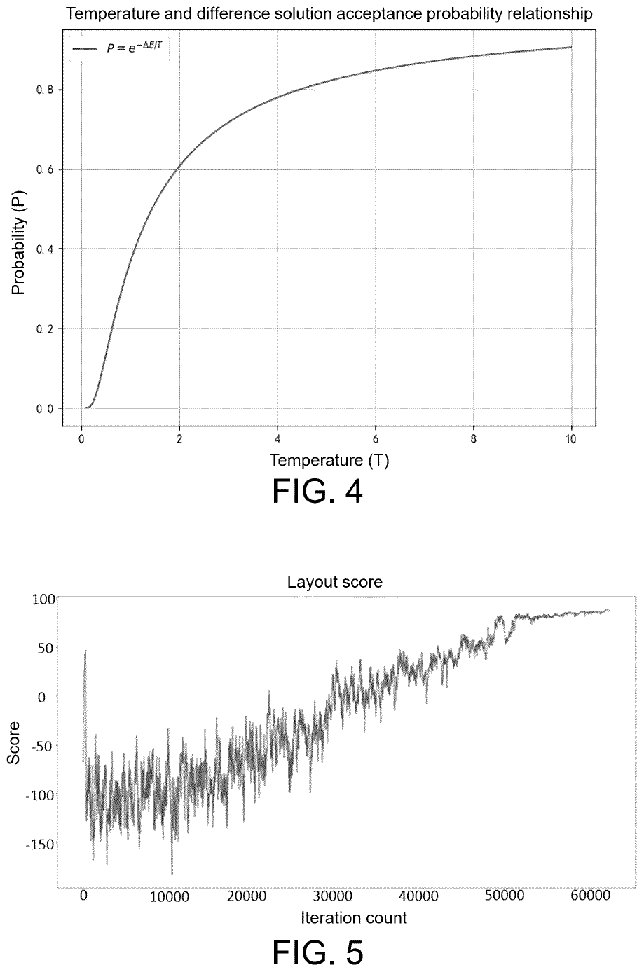

In traditional simulated annealing algorithm, in order to find the optimal solution, the initial temperature of the simulated annealing algorithm is usually set very high, with probability P approaching 1, and then the temperature is gradually reduced to find the optimal solution. However, due to the very high temperature, the process of gradually reducing the temperature to the termination temperature is very slow, that is, the algorithm convergence process is very slow, and the algorithm efficiency is very low. Moreover, in the above step S42, if the condition score f(j)>f(i) is not satisfied, it indicates that the currently generated solution is a poor solution, and then the probability P=e^{([f(i)-f(i)]/t)} will be calculated and a random number will be generated. If the random number is less than P, then the new solution j is accepted. As shown in FIG. 4, FIG. 4 is a relationship curve between temperature and probability in the simulated annealing algorithm. In this process, the higher the temperature, the greater the probability P, and the higher the probability of accepting poor solutions. If the temperature is very large, the probability approaches 1. At this time, whether it is a poor solution or a better solution, both are accepted with a probability of 1. Therefore, it can be concluded that when the temperature is high, the algorithm is performing meaningless disturbance, which will increase the time for the final layout and affect the final layout effect.

In the disclosure, an adaptive initial temperature determination strategy is proposed, that is, first execute the hill climbing algorithm, understand the situation of transistors of the current standard cell to be constructed through the hill climbing algorithm, record the data in the hill climbing process, calculate an adaptive initial temperature that may adapt to the current transistor situation based on the data of the hill climbing algorithm and use it as the temperature starting point of the simulated annealing algorithm, the temperature starting point is T=2*S÷U, based on the temperature starting point, the overall probability in the simulated annealing process may be adjusted to approach P=e^{-0.5}≈0.6, thus enhancing the randomness of accepting poor solutions, and will not be too biased toward accepting poor solutions, compared with traditional algorithms, the disclosure has shorter convergence time and higher efficiency when executing the simulated annealing algorithm.

The following explains the reason why the overall probability approaches P=e^{-0.5} when the initial temperature is set to T=2*S÷U:

$$P = {e}^{- \frac{\vert f ( j ) - f ( i ) \vert}{T}} = {e}^{- \frac{Δ E}{T}} ;$$

average the score change amount obtained during the entire hill climbing period to get ΔE=S÷U;

$$T = 2 ⋆ S \div U ;$$

substituting ΔE and T into the probability calculation formula, P=e^{-0.5} is obtained.

In the disclosure, by first executing the hill climbing algorithm to get the above adaptive initial layout and adaptive initial temperature, the convergence time of the simulated annealing algorithm may be improved and the quality effect of the final solution also has better improvement.

In one embodiment, the simulated annealing algorithm may be executed twice in succession, with the first execution being exploratory, i.e., setting the iteration rounds of the simulated annealing algorithm to several rounds, i.e., performing several rounds of temperature adjustment, with each round performing multiple disturbance, for example 4 to 7 rounds, specifically 5 rounds, calculating all layout scores for each round, determining the layout with the highest layout score and the corresponding temperature, and then executing the simulated annealing algorithm based on the layout with the highest layout score and the corresponding temperature until completion. As shown in FIG. 5, FIG. 5 is a change situation of layout score during simulated annealing algorithm according to an embodiment of the disclosure, it can be seen that after multiple oscillations, it finally converges to a high score value.

Since the quality of solutions obtained by the simulated annealing algorithm during the optimization process may have certain fluctuations, some methods to solve these fluctuations are to record the random number seed of the best solution through testing and set the random number seed for this situation. Obviously, this method has poor generalization and is very wasteful of manpower during the testing and recording process, and the final result may not be very good. In this embodiment, by exploring the initial solution, the layout score during the iteration process may converge more stably with basically no large fluctuations, thereby further accelerating the convergence speed.
Step S5: arrange the transistors in the sequence as the layout of the transistors.

In the disclosure, the solution output by the simulated annealing algorithm is the arrangement of transistors in the sequence, with the arrangement of transistors in the sequence as the layout of transistors.

In specific operations, the layout information of transistors, transistor connection information, and netlist node connection information may be written into a file in json format to obtain a json format file of the layout.

Further, visualization results may also be generated based on json format files, and the specific operation process is:
first, create a white background canvas through the tool numpy, where the width of the image is real_x_max;
next, generate a mos_list, which stores all MOSFET object instances;
draw power rails VDD, VSS, and the width of the power rails;
through function cv2.getTextSize( ) get the connection relationship of transistors, and through function cv2.putText( ) arrange the transistor layout according to the obtained json format file information;
finally, the results are displayed through function cv2.imshow( ) and the visualization results are stored through function cv2.imwrite( ).

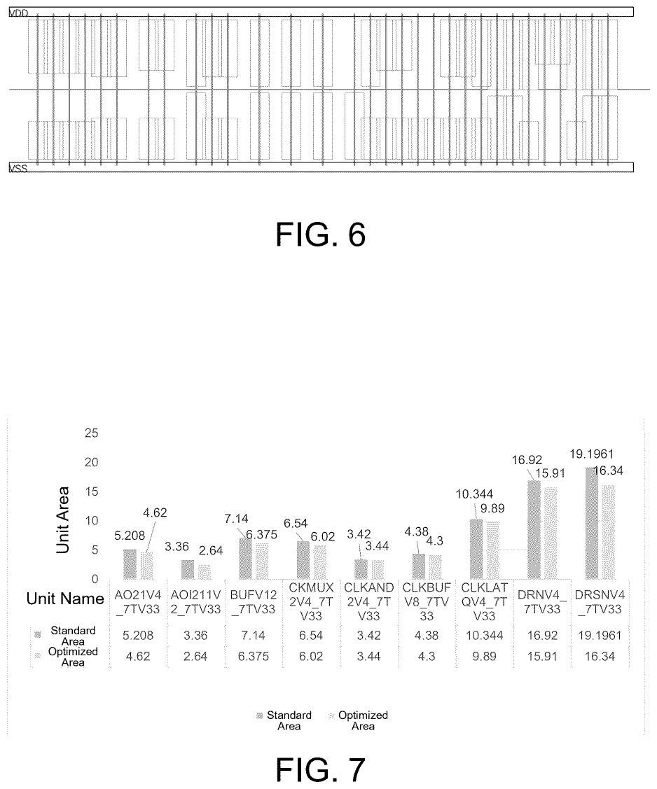

As shown in FIG. 6, FIG. 6 is a visualization image of standard cells obtained according to an embodiment of the disclosure, where each box represents a transistor, and the vertical green lines represent gate line nets.

Taking the layout design of multiple transistor standard cells in a standard cell library as an example, FIG. 7 shows the comparison of layout results through the method of the disclosure and the conventional Virtuoso tool. By comparing the adaptive temperature transistor auto layout method proposed by the disclosure with virtuoso layout, under the premise of consistent optimization targets, the layout area optimization obtained by the disclosure is on average 5% to 10% better than the layout area obtained by the virtuoso tool, indicating that the disclosure ensures optimization effectiveness while improving optimization efficiency, which proves the feasibility and reliability of the method.

Correspondingly, the disclosure also relates to an electronic device, including a memory and a processor, the memory stores a computer program, and the processor executes the computer program to implement the steps of the above method.

The electronic device may be computing devices such as desktop computers, laptops, handheld computers, and cloud servers. The processor may be a Central Processing Unit (CPU), and may also be other general-purpose processors, Digital Signal Processors (DSP), Application Specific Integrated Circuits (ASIC), Field-Programmable Gate Arrays (FPGA), or other programmable logic devices, discrete gates or transistor logic devices, discrete hardware components, etc. The memory may be used to store computer programs and/or modules, and the processor executes the various functions of the electronic device through running or executing the computer programs and/or modules stored in the memory, as well as calling the data stored in the memory.

Correspondingly, the disclosure also relates to a computer-readable storage medium having a computer program stored thereon, and when the computer program is executed by a processor, the steps of the above method are implemented.

Specifically, the memory may include high-speed random access memory, and may also include non-volatile memory, for example, hard disk, memory, plug-in hard disk, Smart Media Card (SMC), Secure Digital (SD) card, Flash Card, at least one magnetic disk storage device, flash memory device, or other volatile solid-state storage device.

The technical features of the embodiments may be combined arbitrarily. To make the description concise, not all possible combinations of the technical features in the embodiments are described. However, as long as the combinations of these technical features do not contradict each other, they should all be considered within the scope described in this specification. It should be noted that “in one embodiment”, “for example”, “as another example”, etc. of the disclosure are intended to illustrate the disclosure by way of example, rather than to limit the disclosure.

The embodiments merely express several implementation modes of the disclosure, and their descriptions are relatively specific and detailed, but should not be understood as limitations on the scope of the claims. It should be pointed out that for ordinary skilled persons in the art, several modifications and improvements may be made without departing from the concept of the disclosure, and these all belong to the protection scope of the disclosure.

What is claimed is:

1. An auto layout method for transistors in standard cells, comprising:
step S1: obtaining information of each of NMOS transistors and PMOS transistors to be laid out;
step S2: pairing the NMOS transistors and the PMOS transistors with common gates, if there are remaining unpaired transistors, then set virtual transistors to pair with them, placing the NMOS transistors and the PMOS transistors in different sequences respectively, randomly initializing positions of each transistor in the sequences while ensuring that the paired transistors are always aligned in their positions within the sequences;
step S3: with a sequence layout as an optimization target and a highest layout score as an optimization objective, executing a hill climbing algorithm to get an adaptive initial layout of the sequence, and calculating an adaptive initial temperature T=2*(an accumulation of score changes obtained from each hill climbing)÷U of the sequence, where U is a hill climbing count, the layout score is a weighted sum of transistor layout indicators;
step S4: based on the adaptive initial layout and the adaptive initial temperature, executing a simulated annealing algorithm to get a final layout of the sequence; and
step S5: arranging the transistors in the sequence as the layout of the transistors;
wherein in step S4, a process of executing the simulated annealing algorithm comprises:
step S41: taking a current layout of the sequence as a current solution i, let an optimal solution S=i;
step S42: disturbing the current solution i to get a new solution j, if score f(j)>f(i), then accept the new solution j and update S-j, otherwise, calculate probability P=e^{([f(j)-f(i)]/t)} and generate a random number greater than 0 and less than 1, if the random number is less than P, then accept the new solution j; t being a current temperature;
step S43: reducing the temperature t; and
step S44: repeating step S42 to step S43 until the temperature t is less than a termination temperature or solution converges, outputting the optimal solution.

2. The auto layout method for transistors in standard cells according to claim 1, wherein in step S4, several rounds of exploratory simulated annealing algorithm are executed first, with the layout having the highest layout score as an initial solution to continue executing the simulated annealing algorithm until completion.

3. The auto layout method for transistors in standard cells according to claim 2, wherein 5 rounds of the exploratory simulated annealing algorithm are executed first.

4. The auto layout method for transistors in standard cells according to claim 1, wherein the disturbance comprises performing 180° rotation of the transistors, transistor position exchange, and transistor position movement.

5. The auto layout method for transistors in standard cells according to claim 1, wherein if there are transistors with widths exceeding standard cell dimensions, their widths are folded to adapt to dimensions of the standard cell.

6. The auto layout method for transistors in standard cells according to claim 1, wherein step S5 comprises: arranging the transistors in the sequence as the layout of the transistors, getting layout information of the transistors, writing the layout information of the transistors, transistor connection information, and netlist node connect information into a file in json format, getting the json format file of the layout.

7. The auto layout method for transistors in standard cells according to claim 1, wherein the layout indicators comprise area, wire length, pin accessibility, layout symmetry, design rule check, and program runtime.

8. An electronic device, comprising a memory and a processor, the memory storing a computer program, wherein the processor implements the steps of the method according to claim 1 when executing the computer program.

9. A computer-readable storage medium, having a computer program stored thereon, wherein the computer program implements the steps of the method according to claim 1 when executed by a processor.
